(19) United States
(12) Patent Application Publication
(10) Pub. No.: US 2026/0186323 A1
(43) Pub. Date: Jul. 2, 2026

(54) ROTATING ASSEMBLY FOR GLASSES AND GLASSES

(71) Applicant: Beijing Zitiao Network Technology Co., Ltd., Beijing (CN)

(72) Inventors: Wenhe ZHAI, Beijing (CN); Chun XIE, Beijing (CN)

(21) Appl. No.: 19/352,139

(22) Filed: Oct. 7, 2025

(30) Foreign Application Priority Data
Dec. 31, 2024 (CN) 202411997149.1

(51) Int. Cl. G02C 5/22; G02C 11/00

(52) U.S. Cl. CPC G02C 5/2227; G02C 11/10

(57) ABSTRACT

This application relates to the technical field of glasses, and in particular, to a rotating assembly for glasses and glasses. The rotating assembly for the glasses includes: a frame seat for connection with a frame; a temple seat for connection with a temple, where the temple seat is rotationally connected to the frame seat, and when stressed, the temple can drive the temple seat to be flipped outward or folded relative to the frame seat; an elastic structure, arranged on one of the frame seat and the temple seat, where when the temple seat is flipped outward and rotated to a first preset angle relative to the frame seat, the elastic structure abuts against the other one, the frame seat limits the rotation of the temple seat, and the first preset angle is greater than 90 degrees.

### CROSS-REFERNCE TO RELATED APPLICATIONS

This application claims priority to Chinese Application No. 202411997149.1 filed December 31, 2024, the disclosure of which is incorporated herein by reference in its entirety.

### FIELD

This application relates to the technical field of glasses, and in particular, to a rotating assembly for glasses and glasses.

### BACKGROUND

Currently, temples and a frame of smart glasses are connected through rotating shafts, thereby allowing the temples to be unfolded or folded relative to the frame for wearing and storage conveniently.

### SUMMARY

In order to solve the above-mentioned technical problems, this application provides a rotating assembly for glasses and glasses.

In a first aspect, this application provides a rotating assembly for glasses, for connecting a frame and a temple of the glasses. The rotating assembly for the glasses includes: a frame seat for connection with the frame; a temple seat for connection with the temple, where the temple seat is rotationally connected to the frame seat, and when stressed, the temple can drive the temple seat to be flipped outward or folded relative to the frame seat; and an elastic structure, arranged on one of the frame seat and the temple seat, where when the temple seat is flipped outward and rotated to a first preset angle relative to the frame seat, the elastic structure abuts against the other one, the frame seat limits the rotation of the temple seat, and the first preset angle is greater than 90 degrees.

In some embodiments, an installation cavity and an opening communicating with the installation cavity are formed in one of the frame seat and the temple seat; and the elastic structure is arranged in the installation cavity, and part of the elastic structure can extend out or retract through the opening.

In some embodiments, the elastic structure includes elastic members and an abutting member, the elastic members are located in the installation cavity, the abutting member includes a first part and a second part in a stepped shape, the first part abuts against the elastic members and is limited within the installation cavity, and the second part can extend out or retract through the opening.

In some embodiments, when the temple seat is flipped outward and rotated to a second preset angle relative to the frame seat, the elastic structure can abut against the other one of the frame seat and the temple seat, and the second preset angle is greater than 0 degrees and less than or equal to 90 degrees.

In some embodiments, the frame seat includes a frame seat body and a first lug plate extending from the frame seat body, the temple seat includes a temple seat body and a second lug plate extending from the temple seat body, and the second lug plate is rotationally connected to the first lug plate; and the elastic structure is arranged on one of the temple seat body and the frame seat body and can abut against the other one.

In some embodiments, two first lug plates and two second lug plates are arranged, the two first lug plates are both located between the two second lug plates, or the two second lug plates are both located between the two first lug plates.

In some embodiments, the rotating assembly for the glasses further includes a wiring member, the wiring member can rotate along with the temple seat, the wiring member has a wiring cavity for an electrical connector of the glasses to pass through, and the frame seat or the temple seat is provided with a wiring channel communicating with the wiring cavity.

In some embodiments, the rotating assembly for the glasses further includes a rotating shaft, and the temple seat and the frame seat are rotationally connected through the rotating shaft, and the wiring member is coaxial with the rotating shaft.

In some embodiments, the temple seat is provided with a third lug plate, and the rotating shaft penetrates through the third lug plate; and the wiring member is provided with a limiting notch that extend in a rotation direction, the third lug plate extend into the limiting notch, can rotate relative to the wiring member within the limiting notch, and can drive the wiring member to rotate.

In some embodiments, the frame seat is provided with the wiring channel, and the wiring member is provided with a limiting protrusion extending into the wiring channel; and the wiring channel is provided with an inner side wall and an outer side wall in a left-right direction of the glasses, and the inner side wall and the outer side wall are configured to limit the limiting protrusion, to limit the rotation of the wiring member.

In some embodiments, when the temple seat is flipped outward and rotated to the first preset angle relative to the frame seat, the limiting protrusion abuts against the inner side wall, and the third lug plate abuts against a first end of the limiting notch in the extension direction; and when the temple seat is completely folded relative to the frame seat, the limiting protrusion abuts against the outer side wall, and the third lug plate abuts against second end of the limiting notch in the extension direction.

In some embodiments, the frame seat is provided with a fourth lug plate; and the wiring member is provided with limiting notch that extends in a rotation direction, and the fourth lug plate extends into the limiting notch to limit the rotation of the wiring member.

In some embodiments, the temple seat is provided with the wiring channel, and the wiring member is provided with a limiting protrusion extending into the wiring channel; and the wiring channel is provided with a first side wall and a second side wall which are oppositely arranged, and both the first side wall and the second side wall can drive the wiring member to rotate in opposite rotation directions through the limiting protrusion; and when the temple seat is flipped outward and rotated to the first preset angle relative to the frame seat, the first side wall and the second side wall are oppositely arranged in a front-back direction of the glasses, and the second side wall is relatively close to the end of the temple that is away from the frame.

In some embodiments, when the temple seat is flipped outward and rotated to the first preset angle relative to the frame seat, the limiting protrusion abuts against the second side wall, and the fourth lug plate abuts against first end of the limiting notch in the extension direction; and when the temple seat is completely folded relative to the frame seat, the limiting protrusion abuts against the first side wall, and the fourth lug plate abuts against second end of the limiting notch in the extension direction.

In some embodiments, the frame seat is provided with an electrical appliance cavity, and the electrical appliance cavity communicates with the wiring channel.

In a second aspect, this application provides glasses, including a temple, a frame, and the rotating assembly for the glasses provided in the first aspect, the temple is connected to the temple seat, and the frame is connected to the frame seat.

In some embodiments, the temple is provided with a first accommodation cavity, and the temple seat is arranged in the first accommodation cavity; and the frame is provided with a second accommodation cavity, and the frame seat is arranged in the second accommodation cavity.

In some embodiments, the glasses are smart glasses.

### BRIEF DESCRIPTION OF THE DRAWINGS

The accompanying drawings herein are incorporated into the specification to form a part of the specification, illustrate embodiments conforming to this application, and are used to explain the principle of this application together with the specification.

In order to more clearly illustrate the technical solutions in the embodiments of this application or in the prior art, the accompanying drawings used for describing the embodiments or the prior art will be briefly described below. Apparently, those of ordinary skill in the art may still derive other accompanying drawings from these accompanying drawings without creative efforts.

FIG. 1 is a schematic structural diagram (having an electrical connector) of a rotating assembly for glasses according to an embodiment of this application;

FIG. 2 is a schematic structural diagram of a rotating assembly for glasses according to an embodiment of this application;

FIG. 3 is an exploded schematic diagram of a rotating assembly for glasses according to an embodiment of this application;

FIG. 4 is a schematic structural diagram of a rotating assembly for glasses from another perspective according to an embodiment of this application;

FIG. 5 is a schematic structural diagram of a rotating assembly for glasses from yet another perspective according to an embodiment of this application;

FIG. 6 is a first schematic sectional view of a rotating assembly for glasses according to some embodiments of this application;

FIG. 7 is a second schematic sectional view of a rotating assembly for glasses according to some embodiments of this application;

FIG. 8 is a third schematic sectional view of a rotating assembly for glasses according to some embodiments of this application;

FIG. 9 is a fourth schematic sectional view of a rotating assembly for glasses according to some embodiments of this application;

FIG. 10 is a first schematic sectional view of a rotating assembly for glasses according to some embodiments of this application;

FIG. 11 is a second schematic sectional view of a rotating assembly for glasses according to some embodiments of this application;

FIG. 12 is a third schematic sectional view of a rotating assembly for glasses according to some embodiments of this application; and

FIG. 13 is a fourth schematic sectional view of a rotating assembly for glasses according to some embodiments of this application.

In the figures, 1-temple seat; 11-temple seat body; 111-installation cavity; 112-opening; 12-second lug plate; 13-third lug plate;

2-frame seat; 21-frame seat body; 211-electrical appliance cavity; 212-wiring channel; 212a-inner side wall; 212b-outer side wall; 22-first lug plate; 23-fourth lug plate;

3-elastic structure; 31-elastic member; 32-abutting member; 321-first part; 322-second part;

4-wiring member; 41-wiring cavity; 42-limiting notch; 42a-first end; 42b-second end; 43-limiting protrusion;

5-rotating shaft; 51-first shaft section; 52-second shaft section;

6-electrical connector;

212c-first side wall; and 212d-second side wall.

### DETAILED DESCRIPTION OF EMBODIMENTS

For a clearer understanding of the above-mentioned objectives, features, and advantages of this application, the solutions of this application will be further described below. It should be noted that embodiments in this application and features in the embodiments may be mutually combined without conflicts.

Many specific details are elaborated in the following description to facilitate a full understanding of this application, but this application may also be implemented in methods different from those described herein. Apparently, the embodiments in the specification are only a part rather all of the embodiments of this application.

The range of unfolding of the temples relative to the frame is limited. When a user with a larger head circumference wears the glasses, the temples are forced apart, which not only affects the stability of the connection between the temples and the frame, making the temples prone to damage, but also results in poor wearing comfort, influencing the user experience.

An embodiment of this application provides a rotating assembly for glasses, for connecting a frame and a temple of the glasses. The glasses may be smart glasses, such as augmented reality (AR) glasses, virtual reality (VR) glasses, and mixed reality (MR) glasses, or daily-use glasses such as sunglasses, myopia glasses, and presbyopia glasses.

Specifically, as shown in FIG. 1 to FIG. 7, the rotating assembly for the glasses includes a temple seat 1, a frame seat 2, and an elastic structure 3. The frame seat 2 is for connection with the frame. The temple seat 1 is for connection with the temple, and is rotationally connected to the frame seat 2. When stressed, the temple can drive the temple seat 1 to be flipped outward or folded relative to the frame seat 2. The elastic structure 3 is arranged on one of the frame seat 2 and the temple seat 1. When the temple seat 1 is rotated and flipped outward to a first preset angle relative to the frame seat 2, the elastic structure 3 abuts against the other one, and the frame seat 2 limits the rotation of the temple seat 1, where the first preset angle is greater than 90 degrees.

It should be understood that since the frame seat 2 and the temple seat 1 are rotationally connected, the temple seat 1 can rotate relative to the frame seat 2. When the temple seat 1 can be flipped outward and rotated to the first preset angle relative to the frame seat 2, and the first preset angle is greater than 90 degrees, the glasses can be suitable for a user with a larger head circumference, and temple damage is not likely to happen. Moreover, the elastic structure 3 provides a restoring force to the temple seat 1, thereby allowing the temples to clamp the head of the user, and thus improving the wearing stability and comfort of the glasses, and reducing the likelihood of temple damage.

It should be noted that when the temple seat 1 is flipped outward and rotated to the first preset angle relative to the frame seat 2, the elastic structure 3 has a maximum compression amount, and in this case, the temple has a maximum opening degree relative to the frame.

For example, if the first preset angle is 95 degrees, the maximum angle at which the temple can be flipped outward from a folded state relative to the frame is 95 degrees. In this case, the elastic structure 3 has the maximum compression amount, and the temple seat 1 is blocked by the frame seat 2 and cannot continue to rotate.

In some embodiments, when the temple seat 1 is flipped outward and rotated to a second preset angle relative to the frame seat 2, the elastic structure 3 can abut against the other one of the frame seat 2 and the temple seat 1, and the second preset angle is greater than 0 degrees and less than or equal to 90 degrees.

In other words, when the temple seat 1 is flipped outward and rotated to 90 degrees or before reaching 90 degrees relative to the frame seat 2, the temple seat 1 and the frame seat 2 jointly compress the elastic structure 3. Accordingly, the elastic structure 3 generates the restoring force on the temple seat 1, thereby allowing the two temples of the glasses to clamp the head of the user, sharing part of the glasses weight, preventing the full weight of the glasses from acting on the nose bridge of the user, and thus improving the wearing comfort of the glasses.

The second preset angle is greater than 0 degrees and less than or equal to 90 degrees. That is, when the second preset angle is greater than 0 degrees and less than 90 degrees, it means that after the temple drives the temple seat 1 to be flipped outward to the second preset angle, the temple seat 1 and the frame seat 2 may compress the elastic structure 3 due to continuous outward flipping, causing the elastic structure 3 to deform and apply a reaction force to the temple seat 1. When the second preset angle is equal to 90 degrees, it indicates that before the temple is flipped outward to 90 degrees relative to the frame, the elastic structure 3 cannot be compressed. When the temple is flipped outward to more than 90 degrees relative to the frame, the elastic structure 3 is compressed and generates the restoring force on the temple seat 1. In this case, the glasses are suitable for the user with the larger head circumference, that is, the temple needs to be opened to a greater extent.

Certainly, the above-mentioned second preset angle may also be set to be greater than 90 degrees. That is, the elastic structure 3 abuts against the other of the frame seat 2 and the temple seat 1 only after the temple drives the temple seat 1 to be flipped outward to more than 90°. In this case, the second preset angle is less than the first preset angle.

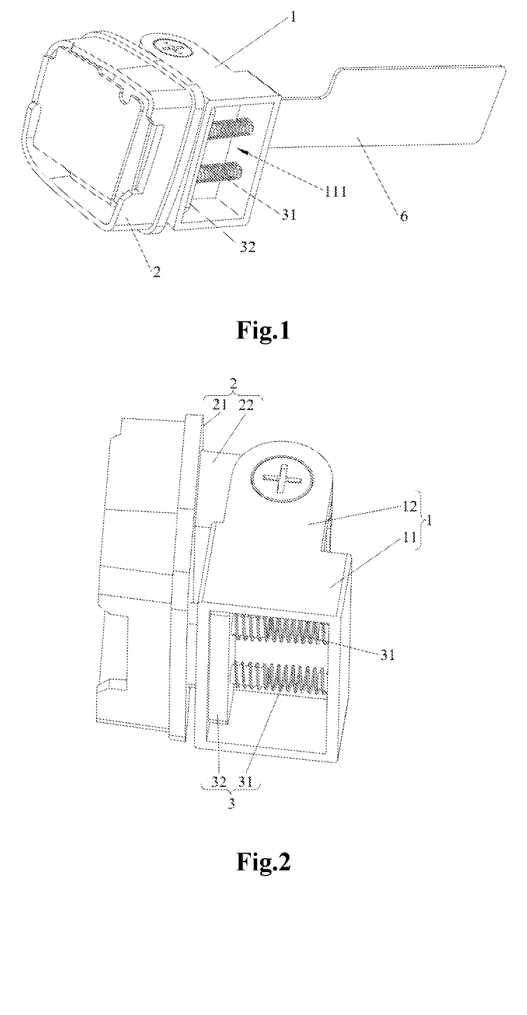

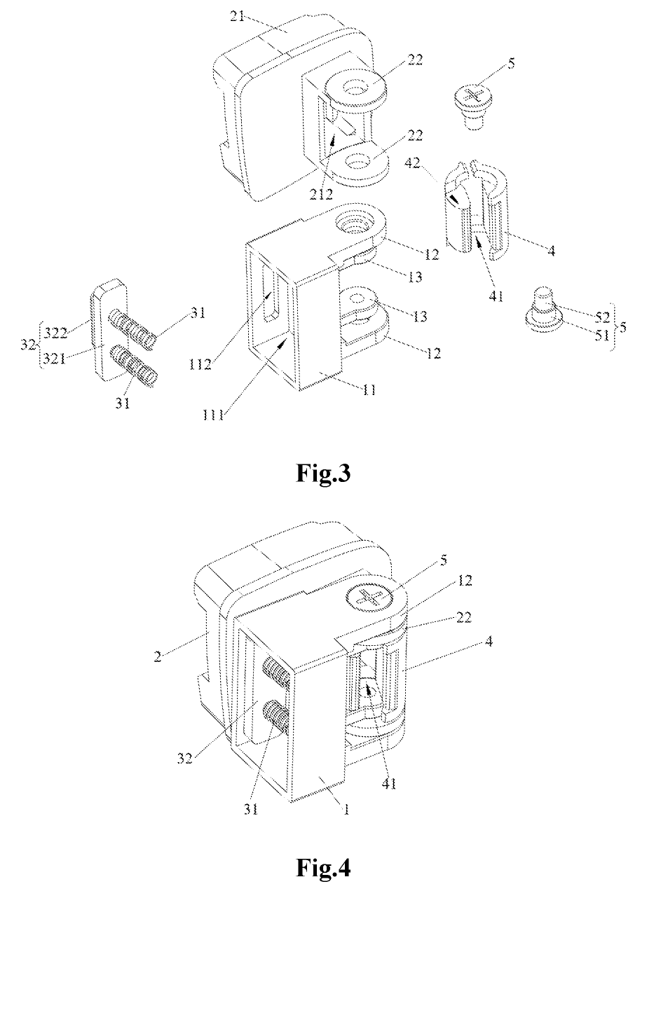

In some embodiments, referring to FIG. 2 and FIG. 3, an installation cavity 111 and an opening 112 communicating with the installation cavity 111 are formed in one of the frame seat 2 and the temple seat 1. The elastic structure 3 is arranged in the installation cavity 111, and part of the elastic structure 3 can extend out or retract through the opening 112.

It should be understood that the elastic structure 3 is in a state of extending out of the opening 112 when the elastic structure 3 does not abut against the other of the frame seat 2 and the temple seat 1, and the elastic structure 3 gradually abuts against the other of the frame seat 2 and the temple seat as the temple seat 1 is flipped outward relative to the frame seat 2 until the temple seat 1 is flipped outward and rotated to the first preset angle relative to the frame seat 2.

Exemplarily, in a specific implementation, referring to FIG. 3, the above-mentioned temple seat 1 is provided with the installation cavity 111, accordingly, the elastic structure 3 is installed on the temple seat 1, and then can abut against the frame seat 2 along with the rotation of the temple seat 1.

The elastic structure 3 includes elastic members 31 and an abutting member 32. The elastic members 31 are located in the installation cavity 111. The abutting member 32 includes a first part 321 and a second part 322 in a stepped shape. The first part 321 abuts against the elastic members 31 and is limited within the installation cavity 111, and the second part 322 can extend out or retract through the opening 112.

In other words, the abutting member 32 is used to abut against the frame seat 2, and the elastic members 31 are used to provide the restoring force to the temple seat 1. Each elastic member 31 may be selected as a spring, a V-shaped spring piece, or an elastic block with elasticity.

Exemplarily, referring to FIG. 3, each of the above-mentioned elastic members 31 is selected as the spring, and two springs are arranged to improve stress uniformity of the abutting member 32.

In some embodiments, referring to FIG. 3 and FIG. 4, the frame seat 2 includes a frame seat body 21 and a first lug plate 22 extending from the frame seat body 21. The temple seat 1 includes a temple seat body 11 and a second lug plate 12 extending from the temple seat body 11. The second lug plate 12 is rotationally connected to the first lug plate 22. The elastic structure 3 is arranged on one of the temple seat body 11 and the frame seat body 21 and can abut against the other one.

It should be understood that the frame seat 2 and the temple seat 1 are rotationally connected through the first lug plate 22 and the second lug plate 12. The rotating assembly for the glasses further includes rotating shaft 5. The rotating shaft 5 penetrates through the first lug plate 22 and the second lug plate 12, thereby implementing the rotational connection between the frame seat 2 and the temple seat 1.

When the temple seat 1 is flipped outward and rotated to 90 degrees relative to the frame seat 2, a preset gap is formed between the temple seat body 11 and the frame seat body 21. The arrangement of the preset gap allows the temple seat 1 to continue rotating and flipping outward relative to the frame seat 2. In this case, the preset gap is set according to the first preset angle. The larger the first preset angle, the larger the preset gap. However, the first preset angle cannot be too large to prevent the glasses from being unwearable.

Further, two first lug plates 22 and two second lug plates 12 are arranged. The two first lug plates 22 are both located between the two second lug plates 12, or the two second lug plates 12 are both located between the two first lug plates 22.

Exemplarily, in a specific implementation, referring to FIG. 3 and FIG. 4, the above-mentioned two first lug plates 22 are both located between the two second lug plates 12. In this case, the rotating shaft assembly for the glasses includes two rotating shafts 5. One rotating shaft 5 penetrates through one second lug plate 12 and one first lug plate 22, and the other rotating shaft 5 penetrates through the other second lug plate 12 and the other first lug plate 22.

The rotating shaft 5 is a stepped shaft. The stepped shaft includes a first shaft section 51 and a second shaft section 52. A diameter of the first shaft section 51 is larger than that of the second shaft section 52, and the first shaft section 51 is provided with an external thread. In this case, the second lug plate 12 is provided with a threaded hole, and the first lug plate 22 is provided with a plain hole. Therefore, the stepped shaft is in threaded connection with the second lug plate 12 through the first shaft section 51, and the second shaft section 52 extends into the plain hole in the first lug plate 22, thereby implementing the rotational connection between the second lug plate 12 and the first lug plate 22.

Referring to FIG. 3 to FIG. 7, the rotating assembly for the glasses further includes a wiring member 4. The wiring member 4 can rotate along with the temple seat 1. The wiring member 4 has a wiring cavity 41 for an electrical connector 6 of the glasses to pass through. The frame seat 2 is provided with a wiring channel 212 communicating with the wiring cavity 41.

It should be understood that by arranging the wiring member 4, the wiring member 4 can rotate along with the temple seat 1 and is provided with the wiring cavity 41, and the frame seat 2 is provided with the wiring channel 212, thereby facilitating the electrical connector 6 of the glasses to pass through the wiring member 4 and the wiring channel 212, and thus implementing transmission of electrical signals and control signals.

For example, a battery and a main board are arranged inside the temple, and the frame is provided with a camera structure. The electrical connector 6 serves to connect the camera structure with the main board, thereby facilitating the main board to control the on/off of the camera structure.

The electrical connector 6 may be selected as a flexible printed circuit (FPC).

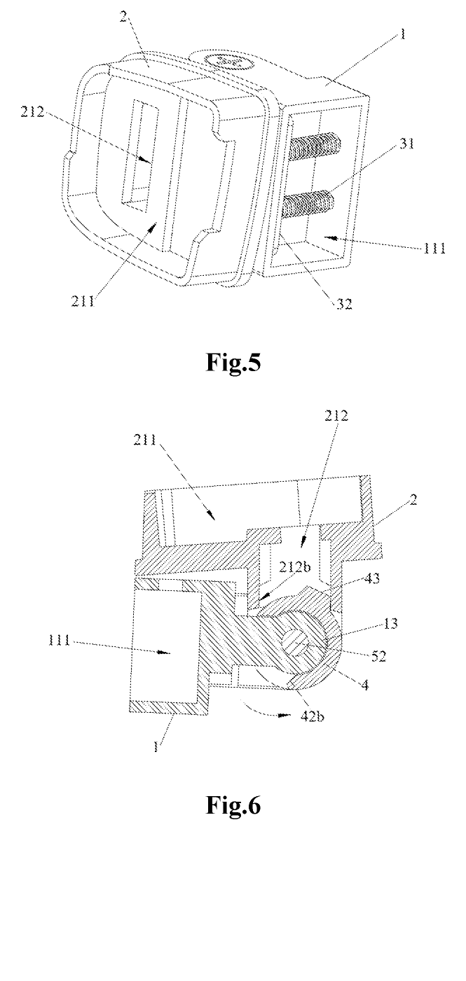

Furthermore, referring to FIG. 5, the above-mentioned frame seat 2 is further provided with an electrical appliance cavity 211, and the electrical appliance cavity 211 communicates with the wiring channel 212.

It should be understood that by arranging the electrical appliance cavity 211 in the frame seat 2 and the electrical appliance cavity 211 communicating with the wiring channel 212, elements of the glasses or part of the electrical connector 6 can be accommodated in the electrical appliance cavity 211.

The frame seat 2 includes the frame seat body 21 and the first lug plate 22 extending from the frame seat body 21. The above-mentioned wiring channel 212 is formed between the two first lug plates 22. The frame seat body 21 is provided with the above-mentioned electrical appliance cavity 211, and a bottom plate of the electrical appliance cavity 211 is provided with a through hole through which the wiring channel 212 communicates with the electrical appliance cavity 211.

Further, the rotating assembly for the glasses further includes the rotating shaft 5. The temple seat 1 and the frame seat 2 are rotationally connected through the rotating shaft 5, and the above-mentioned wiring member 4 is coaxial with the rotating shaft 5.

It should be understood that the wiring member 4 is coaxial with the rotating shaft 5, such that a relative position between the wiring member 4 and the rotating shaft 5 remains unchanged during rotation. The wiring member 4 rotates with the temple seat 1 to play a role in pushing the electrical connector 6, such that the electrical connector 6 can move when the temple seat 1 rotates, thereby preventing the electrical connector 6 from being stuck.

In some embodiments, the above-mentioned temple seat 1 is provided with a third lug plate 13, and the rotating shaft 5 penetrates through the third lug plate 13. The wiring member 4 is provided with limiting notch 42 that extend in a rotation direction.

Exemplarily, in a specific implementation, the third lug plate 13 extends into the limiting notch 42 and can rotate relative to the wiring member 4 within the limiting notch 42. When the third lug plate 13 abut against end portions of the limiting notch 42 in an extension direction, the wiring member 4 can be driven to rotate.

It should be understood that the above-mentioned wiring member 4 does not rotate synchronously with the temple seat 1 but through the cooperation between the third lug plate 13 and the limiting notch 42. When the third lug plate 13 does not abut against the end portions of the limiting notch 42 in the extension direction, the third lug plate 13 rotates relative to the wiring member 4, and in this case, the wiring member 4 does not rotate. Only when the third lug plate 13 abuts against the end portions of the limiting notch 42 in the extension direction, the third lug plate 13 can drive the wiring member 4 to rotate. Accordingly, a rotation angle of the wiring member 4 is smaller than that of the temple seat 1, which can prevent the electrical connector 6 of the glasses from being driven by the wiring member 4 to be greatly bent due to the large rotation angle of the wiring member 4.

Two third lug plates 13 are arranged. Correspondingly, two ends of the wiring member 4 in an axis direction are both provided with the limiting notch 42. The two third lug plates 13 extend into the two limiting notches 42 respectively, and accordingly, the wiring member 4 is stably driven to rotate through the two third lug plates 13.

Referring to FIG. 6 to FIG. 9, the above-mentioned frame seat 2 is provided with the wiring channel 212. The above-mentioned wiring member 4 is provided with a limiting protrusion 43 extending into the wiring channel 212. The wiring channel 212 is provided with an inner side wall 212a and an outer side wall 212b in a left-right direction of the glasses, and the inner side wall 212a and the outer side wall 212b are used to limit the limiting protrusion 43, thereby limiting the rotation of the wiring member 4. The left-right direction of the glasses refers to an arrangement direction of two lenses of the glasses. The two temples of the glasses are located on two sides of the frame in the left-right direction of the glasses. In the left-right direction of the glasses, the inner side wall 212a is located on the inner side of the outer side wall 212b, and in this case, the inner side wall 212a is relatively close to the other frame seat 2 of the glasses.

In other words, the limiting protrusion 43 cooperates with the inner side wall 212a and the outer side wall 212b to limit the rotation of the wiring member 4 and also remind the user, thereby allowing the user to accurately perceive the position of the temple seat 1 and thus accurately determining whether the temples are completely folded or completely unfolded relative to the frame.

Specifically, referring to FIG. 6, when the temple seat 1 is flipped outward and rotated to the first preset angle relative to the frame seat 2, the temple seat 1 is in a completely unfolded state relative to the frame seat 2. The limiting protrusion 43 abuts against the inner side wall 212a, and the third lug plate 13 abuts against first end 42a of the limiting notch 42 in the extension direction .Referring to FIG. 8, when the temple seat 1 is completely folded relative to the frame seat 2, the limiting protrusion 43 abuts against the outer side wall 212b, and the third lug plate 13 abuts against second end 42b of the limiting notch 42 in the extension direction.

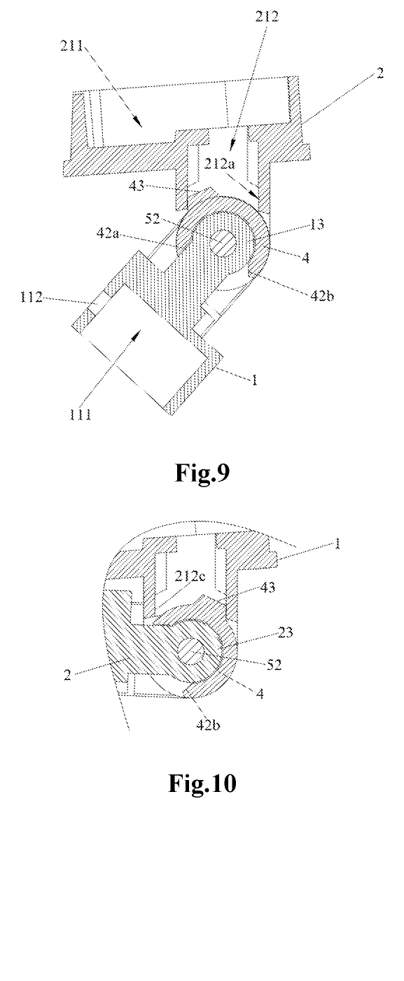

Accordingly, when the temple seat 1 is unfolded from a completely folded state relative to the frame seat 2, the temple seat 1 is rotated outward. In this case, the third lug plate 13 loses contact with the second end 42b of the limiting notch 42 and move towards the first end 42a of the limiting notch 42. In the process, the wiring member 4 remains stationary until the third lug plate 13 makes contact with the first end 42a of the limiting notch 42, as shown in FIG. 9. Then, the third lug plate 13 drives the wiring member 4 to rotate, causing the limiting protrusion 43 to lose contact with the outer side wall 212b. As the temple seat 1 continues to rotate, the limiting protrusion 43 makes contact with the inner side wall 212a, and the wiring member 4 cannot rotate, causing the temple seat 1 to be unable to rotate. In this case, an angle through which the temple seat 1 is flipped outward and rotated from the completely folded state relative to the frame seat 2 is the first preset angle, and the temple seat 1 is in the completely unfolded state relative to the frame seat 2, as shown in FIG. 6.

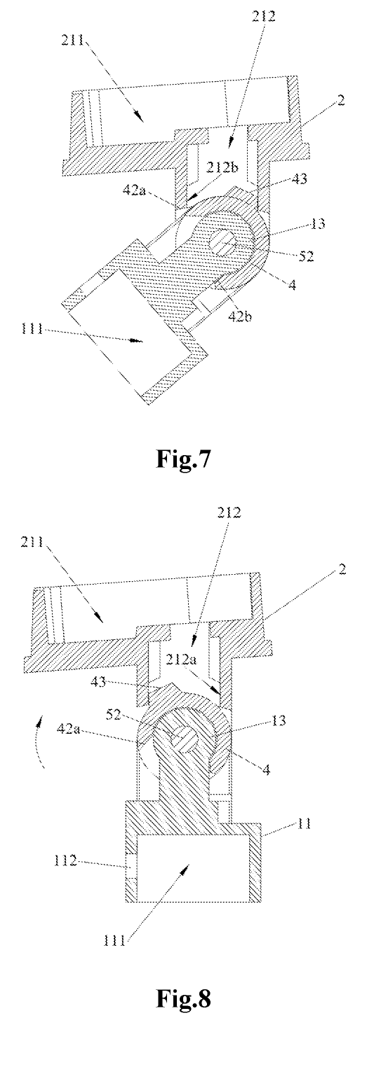

When the temple seat 1 is converted from the completely unfolded state to the completely folded state relative to the frame seat 2, the temple seat 1 is rotated inward. In this case, the third lug plate 13 loses contact with the first end 42a of the limiting notch 42 and move towards the second end 42b of the limiting notch 42. In the process, the wiring member 4 remains stationary until the third lug plate 13 make contact with the second end 42b of the limiting notch 42, as shown in FIG. 7. Then, the third lug plate 13 drives the wiring member 4 to rotate, thereby causing the limiting protrusion 43 to lose contact with the inner side wall 212a. As the temple seat 1 continues to rotate, the limiting protrusion 43 makes contact with the outer side wall 212b, and the wiring member 4 cannot rotate, causing the temple seat 1 to be unable to rotate. In this case, an angle through which the temple seat 1 is flipped inward and rotated from the completely unfolded state relative to the frame seat 2 is the first preset angle, and the temple seat 1 is in the folded state relative to the frame seat 2, as shown in FIG. 8.

Specifically, the above-mentioned frame seat 2 includes the frame seat body 21 and the first lug plate 22 extending from the frame seat body 21. The temple seat 1 includes the temple seat body 11 and the second lug plate 12 extending from the temple seat body 11. The second lug plate 12 is rotationally connected to the first lug plate 22. The elastic structure 3 is arranged on one of the temple seat body 11 and the frame seat body 21, and can abut against the other one.

It should be understood that the frame seat 2 and the temple seat 1 are rotationally connected through the first lug plate 22 and the second lug plate 12. The rotating assembly for the glasses further includes the rotating shaft 5. The rotating shaft 5 penetrates through the first lug plate 22 and the second lug plate 12, thereby implementing the rotational connection between the frame seat 2 and the temple seat 1.

Two first lug plates 22 and two second lug plates 12 are arranged. The two first lug plates 22 are both located between the two second lug plates 12. In this case, the rotating shaft assembly for the glasses includes the two rotating shafts 5. One rotating shaft 5 penetrates through one second lug plate 12 and one first lug plate 22, and the other rotating shaft 5 penetrates through the other second lug plate 12 and the other first lug plate 22.

The rotating shaft 5 is the stepped shaft. The stepped shaft includes the first shaft section 51 and the second shaft section 52. The diameter of the first shaft section 51 is larger than that of the second shaft section 52, and the first shaft section 51 is provided with an external thread. In this case, the second lug plate 12 is provided with a threaded hole, and the first lug plate 22 is provided with a plain hole. Therefore, the stepped shaft is in threaded connection with the second lug plate 12 through the first shaft section 51, and the second shaft section 52 extends into the plain hole in the first lug plate 22, thereby implementing the rotational connection between the second lug plate 12 and the first lug plate 22.

Further, a temple assembly for the glasses includes two third lug plates 13 extending from the temple seat body 11. The two third lug plates 13 are located between the two first lug plates 22, the limiting notches 42 are arranged at the two ends of the wiring member 4 in the axis direction, and the two third lug plates 13 correspond to the two limiting notches 42 respectively.

Exemplarily, in another specific implementation, the above-mentioned temple seat is provided with a third lug plate. Rotating shaft penetrates through the third lug plates, a wiring member is provided with a limiting notch extending in a rotation direction, and the third lug plate extends into the limiting notch to drive the wiring member to rotate. When abutting against end portions of the limiting notch in the extension direction, the third lug plate can rotate relative to the wiring member within the limiting notch.

Exemplarily, the third lug plate is provided with a first arc surface that extends in the rotation direction of the rotating shaft, while the wiring member has a second arc surface that extends in the rotation direction of the rotating shaft. The first arc surface is attached to the second arc surface, and there is a large frictional force between the first arc surface and the second arc surface. Therefore, when the third lug plate rotates, the wiring member is driven to rotate.

Two third lug plates are arranged. Correspondingly, two ends of the wiring member in an axis direction are both provided with the limiting notches. The two third lug plates extend into the two limiting notches respectively, and accordingly, the wiring member is stably driven to rotate through the two third lug plates.

The above-mentioned temple seat is provided with a wiring channel. The above-mentioned wiring member is provided with a limiting protrusion extending into the wiring channel. The wiring channel is provided with an inner side wall and an outer side wall in a left-right direction of the glasses, and the inner side wall and the outer side wall are used to limit the limiting protrusion, thereby limiting the rotation of the wiring member. In the left-right direction of the glasses, the inner side wall is located on an inner side of the outer side wall, and in this case, the inner side wall is relatively close to the other frame seat of the glasses.

In other words, the limiting protrusion cooperates with the inner side wall and the outer side wall to limit the rotation of the wiring member and also remind the user, thereby allowing the user to accurately perceive the position of the temple seat and thus accurately determining whether the temples are completely folded or completely unfolded relative to the frame.

Specifically, when the temple seat is flipped outward and rotated to the first preset angle relative to the frame seat, the limiting protrusion abuts against the inner side wall, and the third lug plate abuts against first end of the limiting notch in the extension direction. When the temple seat is completely folded relative to the frame seat, the limiting protrusion abuts against the outer side wall, and the third lug plate abuts against second end of the limiting notch in the extension direction.

Accordingly, when the temple seat is unfolded from the completely folded state relative to the frame seat, the temple seat is rotated outward, and in this case, the third lug plate drives the wiring member to rotate until the limiting protrusion makes contact with the inner side wall. After the limiting protrusion makes contact with the inner side wall, the wiring member cannot rotate due to the obstruction of the inner side wall. Subsequently, the third lug plate rotates relative to the wiring member within the limiting notch until the third lug plate moves from the second end of the limiting notch to the first end of the limiting notch. In this case, the third lug plate is limited by the first end of the limiting notch and cannot rotate. Accordingly, an angle through which the temple seat is flipped outward and rotated outward from the completely folded state relative to the frame seat is the first preset angle, and the temple seat is in the completely unfolded state relative to the frame seat.

When the temple seat is converted from the completely unfolded state to the completely folded state relative to the frame seat, the temple seat is rotated inward, and in this case, the third lug plate drives a limiting member to rotate until the limiting protrusion makes contact with the outer side wall. After the limiting protrusion makes contact with the outer side wall, the wiring member cannot rotate due to the obstruction of the outer side wall. Subsequently, the third lug plate rotate relative to the wiring member within the limiting notch until the third lug plate move from the first end of the limiting notch to the second end of the limiting notch. In this case, the third lug plate is limited by the second end of the limiting notch and cannot rotate. Accordingly, an angle through which the temple seat is flipped and rotated inward from the completely unfolded state relative to the frame seat is the first preset angle, and the temple seat is in the completely folded state relative to the frame seat.

In some other embodiments, referring to FIG. 10 to FIG. 13, the frame seat 2 is provided with fourth lug plate 23. The wiring member 4 is provided with the limiting notch 42 that extend in the rotation direction. The fourth lug plate 23 extends into the limiting notch 42 to limit the rotation of the wiring member 4.

It should be understood that the wiring member 4 can rotate along with the temple seat 1, while the fourth lug plate 23 can limit the rotation of the wiring member 4, thereby limiting the rotation of the temple seat 1 through the fourth lug plate 23.

Two fourth lug plates 23 are arranged. Correspondingly, two ends of the wiring member 4 in the axis direction are both provided with the limiting notch 42. The two fourth lug plates 23 extend into the two limiting notches 42 respectively, and accordingly, the wiring member 4 is stably driven to rotate through the two fourth lug plates 23.

Referring to FIG. 10 to FIG. 13, the temple seat 1 is provided with the wiring channel 212, and the above-mentioned wiring channel 4 is provided with the limiting protrusion 43 extending into the wiring channel 212. The wiring channel 212 is provided with a first side wall 212c and a second side wall 212d, which are oppositely arranged. Both the first side wall 212c and the second side wall 212d can drive the wiring member 4 to rotate in opposite rotation directions through the limiting protrusion 43.

When the temple seat 1 is flipped outward and rotated to the first preset angle relative to the frame seat 2, the first side wall 212c and the second side wall 212d are oppositely arranged in a front-back direction of the glasses, and the second side wall 212d is relatively close to the end of the temple that is away from the frame. The front-back direction of the glasses is perpendicular to the left-right direction of the glasses. The left-right direction of the glasses refers to the arrangement direction of the two lenses of the glasses. The two temples of the glasses are located on two sides of the frame in the left-right direction of the glasses.

In other words, the limiting protrusion 43 cooperates with the first side wall 212c and the second side wall 212d to drive the wiring member 4 to rotate. In this case, the wiring member 4 does not rotate synchronously with the temple seat 1. The wiring member 4 can only be driven to rotate after the first side wall 212c or the second side wall 212d makes contact with the limiting protrusion 43, and accordingly, the rotation angle of the wiring member 4 is smaller than that of the temple seat 1, which can prevent the electrical connector 6 of the glasses from being driven by the wiring member 4 to be greatly bent due to the large rotation angle of the wiring member 4.

Specifically, referring to FIG. 10, when the temple seat 1 is flipped outward and rotated to the first preset angle relative to the frame seat 2, the limiting protrusion 43 abuts against the second side wall 212d, and the fourth lug plate 23 abuts against the first end 42a of the limiting notch 42 in the extension direction, and in this case, the temple seat 1 is in the completely unfolded state relative to the temple seat 2. Referring to FIG. 12, when the temple seat 1 is completely folded relative to the frame seat 2, the limiting protrusion 43 abuts against the first side wall 212c, and the fourth lug plate 23 abuts against the second end 42b of the limiting notch 42 in the extension direction.

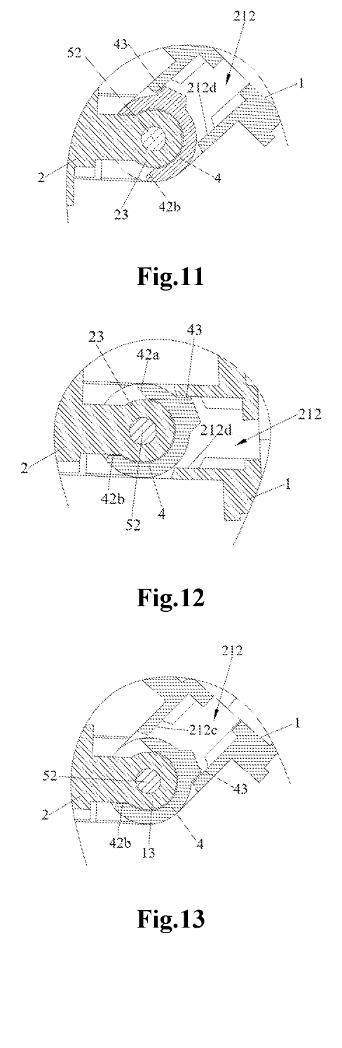

Accordingly, when the temple seat 1 is folded from the completely unfolded state relative to the frame seat 2, the temple seat 1 is rotated inward, in this case, since the limiting protrusion 43 abuts against the second side wall 212d, the temple seat 1 rotates relative to the wiring member 4, and in this case, the wiring member 4 remains stationary relative to the frame seat 2 until the temple seat 1 rotates to cause the first side wall 212c to abut against the limiting protrusion 43, as shown in FIG. 11. The temple seat 1 continues to rotate, and the first side wall 212c and the limiting protrusion 43 drive the wiring member 4 to rotate until the fourth lug plate 23 make contact with the second end 42b of the limiting notch 42 in the extension direction. In this case, the fourth lug plate 23 limit the wiring member 4, thereby limiting the temple seat 1. In this case, the temple seat 1 is flipped inward and rotated to the first preset angle relative to the frame seat 2, as shown in FIG. 12.

When the temple seat 1 is unfolded from the completely folded state, the temple seat 1 is rotated outward, in this case, since the limiting protrusion 43 abuts against the first side wall 212c, the temple seat 1 rotates relative to the wiring member 4, and in this case, the wiring member 4 remains stationary relative to the frame seat 2 until the temple seat 1 rotates to cause the second side wall 212d to abut against the limiting protrusion 43, as shown in FIG. 13. The temple seat 1 continues to rotate, and the second side wall 212d and the limiting protrusion 43 drive the wiring member 4 to rotate until the fourth lug plate 23 makes contact with the first end 42a of the limiting notch 42 in the extension direction. In this case, the fourth lug plate 23 limits the wiring member 4, thereby limiting the temple seat 1. In this case, the temple seat 1 is flipped outward and rotated to the first preset angle relative to the frame seat 2, as shown in FIG. 10.

An embodiment of this application further provides glasses, including the above-mentioned rotating shaft assembly for the glasses. The glasses may be smart glasses, such as AR glasses, VR glasses, and MR glasses, or daily-use glasses, such as sunglasses, myopia glasses, and presbyopia glasses.

The above-mentioned glasses further include a temple and a frame, where the temple is connected to the temple seat 1, the frame is connected to the frame seat 2, and the temple can drive the temple seat 1 to rotate relative to the frame seat 2, to cause the temple to be flipped inward and folded or flipped outward and unfolded relative to the frame.

The temple is provided with a first accommodation cavity, and the temple seat 1 is arranged in the first accommodation cavity. The frame is provided with a second accommodation cavity, and the frame seat 2 is arranged in the second accommodation cavity.

Specifically, the frame seat body 21 of the above-mentioned frame seat 2 is located in the second accommodation cavity, while the first lug plate 22 extends outside the second accommodation cavity.

Further, the above-mentioned glasses include the frame and the two temples, and each temple and the frame are rotationally connected through the above-mentioned rotating shaft assembly for the glasses.

It should be noted that herein, relational terms such as "first" and "second" are used only to distinguish one entity or operation from another and do not necessarily require or imply any actual relationship or order between these entities or operations. Moreover, the terms "include", "including", or any of their variants are intended to cover a non-exclusive inclusion, such that a process, a method, an article, or a device that includes a list of elements not only includes those elements but also includes other elements that are not expressly listed, or further includes elements inherent to such process, method, article, or device. In the absence of more restrictions, an element defined by "including a/an …" does not exclude another identical element in a process, a method, an article, or a device that includes the element.

The above-mentioned description illustrates merely specific implementations of this application, such that those skilled in the art can understand or implement this application. Various modifications to these embodiments are apparent to those skilled in the art, and the general principle defined herein may be implemented in other embodiments without departing from the spirit or scope of this application. Therefore, this application will not be limited to the embodiments shown herein but needs to conform to a widest scope consistent to the principles and novel characteristics disclosed herein.

I/We claim:

1. A rotating assembly for glasses, for connecting a frame and a temple of the glasses, wherein the rotating assembly for the glasses comprises:
a frame seat for connection with the frame;
a temple seat for connection with the temple, wherein the temple seat is rotationally connected to the frame seat, and in response to the temple being stressed, the temple can drive the temple seat to be flipped outward or folded relative to the frame seat; and
an elastic structure, arranged on one of the frame seat and the temple seat, wherein in response to the temple seat being flipped outward and rotated to a first preset angle relative to the frame seat, the elastic structure abuts against the other one, the frame seat limits the rotation of the temple seat, and the first preset angle is greater than 90 degrees.

2. The rotating assembly for the glasses according to claim 1, wherein an installation cavity and an opening communicating with the installation cavity are formed in one of the frame seat and the temple seat; and
the elastic structure is arranged in the installation cavity, and a part of the elastic structure can extend out or retract through the opening.

3. The rotating assembly for the glasses according to claim 2, wherein the elastic structure comprises elastic members and an abutting member, the elastic members are located in the installation cavity, the abutting member comprises a first part and a second part in a stepped shape, the first part abuts against the elastic members and is limited within the installation cavity, and the second part can extend out or retract through the opening.

4. The rotating assembly for the glasses according to claim 1, wherein in response to the temple seat being flipped outward and rotated to a second preset angle relative to the frame seat, the elastic structure can abut against the other one of the frame seat and the temple seat, and the second preset angle is greater than 0 degrees and less than or equal to 90 degrees.

5. The rotating assembly for the glasses according to claim 1, wherein the frame seat comprises a frame seat body and a first lug plate extending from the frame seat body, the temple seat comprises a temple seat body and a second lug plate extending from the temple seat body, and the second lug plate is rotationally connected to the first lug plate; and
the elastic structure is arranged on one of the temple seat body and the frame seat body and can abut against the other one.

6. The rotating assembly for the glasses according to claim 5, wherein two first lug plates and two second lug plates are arranged, and the two first lug plates are both located between the two second lug plates, or the two second lug plates are both located between the two first lug plates.

7. The rotating assembly for the glasses according to claim 1, further comprising a wiring member, wherein the wiring member can rotate along with the temple seat, the wiring member has a wiring cavity for an electrical connector of the glasses to pass through, and the frame seat or the temple seat is provided with a wiring channel communicating with the wiring cavity.

8. The rotating assembly for the glasses according to claim 7, further comprising a rotating shaft, wherein the temple seat and the frame seat are rotationally connected through the rotating shaft, and
the wiring member is coaxial with the rotating shaft.

9. The rotating assembly for the glasses according to claim 8, wherein the temple seat is provided with a third lug plate, and the rotating shaft penetrates through the third lug plate; and
the wiring member is provided with a limiting notch that extend in a rotation direction, the third lug plate extend into the limiting notch, can rotate relative to the wiring member within the limiting notch, and can drive the wiring member to rotate.

10. The rotating assembly for the glasses according to claim 9, wherein the frame seat is provided with the wiring channel, and the wiring member is provided with a limiting protrusion extending into the wiring channel; and
the wiring channel is provided with an inner side wall and an outer side wall in a left-right direction of the glasses, and the inner side wall and the outer side wall are configured to limit the limiting protrusion, to limit rotation of the wiring member.

11. The rotating assembly for the glasses according to claim 10, wherein in response to the temple seat being flipped outward and rotated to the first preset angle relative to the frame seat, the limiting protrusion abuts against the inner side wall, and the third lug plate abuts against a first end of the limiting notch in the extension direction; and
in response to the temple seat being completely folded relative to the frame seat, the limiting protrusion abuts against the outer side wall, and the third lug plate abuts against a second end of the limiting notch in the extension direction.

12. The rotating assembly for the glasses according to claim 8, wherein the frame seat is provided with a fourth lug plate; and
the wiring member is provided with a limiting notch that extends in a rotation direction, and the fourth lug plate extends into the limiting notch to limit rotation of the wiring member.

13. The rotating assembly for the glasses according to claim 12, wherein the temple seat is provided with the wiring channel, and the wiring member is provided with a limiting protrusion extending into the wiring channel;
the wiring channel is provided with a first side wall and a second side wall which are oppositely arranged, and both the first side wall and the second side wall can drive the wiring member to rotate in opposite rotation directions through the limiting protrusion; and
in response to the temple seat being flipped outward and rotated to the first preset angle relative to the frame seat, the first side wall and the second side wall are oppositely arranged in a front-back direction of the glasses, and the second side wall is relatively close to the end of the temple that is away from the frame.

14. The rotating assembly for the glasses according to claim 13, wherein in response to the temple seat being flipped outward and rotated to the first preset angle relative to the frame seat, the limiting protrusion abuts against the second side wall, and the fourth lug plate abuts against a first end of the limiting notch in the extension direction; and
in response to the temple seat being completely folded relative to the frame seat, the limiting protrusion abuts against the first side wall, and the fourth lug plate abuts against a second end of the limiting notch in the extension direction.

15. The rotating assembly for the glasses according to claim 7, wherein the frame seat is provided with an electrical appliance cavity, and the electrical appliance cavity communicates with the wiring channel.

16. Glasses, comprising a temple, a frame, and the rotating assembly for the glasses according to claim 1, wherein the temple is connected to the temple seat, and the frame is connected to the frame seat.

17. The glasses according to claim 16, wherein the temple is provided with a first accommodation cavity, and the temple seat is arranged in the first accommodation cavity; and
the frame is provided with a second accommodation cavity, and the frame seat is arranged in the second accommodation cavity.

18. The glasses according to claim 16, wherein the glasses are smart glasses.

19. An electronic device, comprising glasses, wherein the glasses further comprises a temple, a frame, and the rotating assembly for the glasses according to claim 1, wherein the temple is connected to the temple seat, and the frame is connected to the frame seat.

20. The device according to claim 19, wherein the temple is provided with a first accommodation cavity, and the temple seat is arranged in the first accommodation cavity; and
the frame is provided with a second accommodation cavity, and the frame seat is arranged in the second accommodation cavity.
